(19) United States
(12) Patent Application Publication
(10) Pub. No.: US 2024/0217352 A1
(43) Pub. Date: Jul. 4, 2024

(54) Untethered charging apparatus for electric vehicles in remote areas in lieu of charging stations.

(71) Applicant: Mehrdad Naderian, Newburgh, IN (US)

(72) Inventor: Mehrdad Naderian, Newburgh, IN (US)

(21) Appl. No.: 18/104,302

(22) Filed: Feb. 1, 2023

Related U.S. Application Data
(60) Provisional application No. 63/436,658, filed on Jan. 2, 2023.

(51) Int. Cl. B60L 53/12; B60L 53/36; B60L 53/38; B60L 53/57; H02J 50/10; H02J 50/40

(52) U.S. Cl. CPC B60L 53/12; B60L 53/36; B60L 53/38; B60L 53/57; H02J 50/10; H02J 50/40

(57) ABSTRACT

An apparatus for generating power to charge batteries onboard electric vehicles whereby magnetic bars are embedded in pavement to energize winding coil(s) mounted beneath electric vehicles. The batteries are charged as electric vehicles drive down the Interstate or State Highways over the magnetic bars at designated speed.

### BACKGROUND OF THE INVENTION

It is all but certain that all the pollution the fossil fuel has emitted into the atmosphere is causing global warming and climate change. In an effort to slow this colossal disaster nations are turning to electric vehicles (EVs) which unfortunately not only do they still rely on greenhouse-gas-producing power plants to charge up their batteries, but they also have a limited range.

Just to give an example as to how dire the situation is getting, back on Aug. 24, 2022, the State of California announced phasing out gasoline-engine vehicles in lieu of EVs by 2035. A week later they asked EV owners not to charge their vehicles during the peak hours, due to the shortage of electricity caused by drought.

It is the object of this invention to maintain and supplement charging of electric vehicles as they travel outside the city limits. Currently there are very limited or no charging stations on Interstate Highways which hinders their appeal as a viable means of transportation to the traveling public or transporting goods and services by the industries.

This invention charges EVs as they are traveling down the highways;
Without any additional pollution or carbon emission into the atmosphere.
Without taxing power grids or requiring power poles and lines.
Without the need for constructing thousands of charging stations across the Country.
Without wasting any time waiting for batteries to be charged while traveling.
Without any charging cost to motorists.

In the world of electrons and protons it is common knowledge (Faraday's Law) that by passing a copper wire through a magnetic field, voltage and current is generated in that wire, hence the principle the generators are built on.

An outside energy source like a power plant, gas engine, hydroelectric dam or wind is utilized to spin the generator and produce electricity.

The object of the present invention is to generate current by restructuring and reconfiguring components like what is used in the making of a conventional generator in order to charge EVs as they drive down the highways.

In an effort to cut back on greenhouse effects, there is a global attempt among industrial nations to phase out internal combustion vehicles in lieu of EVs. Unfortunately, their limited range keeps them from being a viable alternative until every gas station outside the city limits in the country is accompanied by a charging station beside it.

After decades of construction and spending an enormous budget, a transformation of this magnitude is not entirely impossible, however these charging stations still rely on power plants to power them up which could take away the benefits of converting to EVs to cut back on greenhouse gasses.

Furthermore, the biggest obstacle that cannot be conquered, is to expect a family going on vacation, or a businessman going to a meeting to wait in a charging station for a couple of hours every few hundred miles to charge their EVs.

There are other charging methods like wireless charging pads being experimented with that are like charging stations and share the same challenges. They require additional power supply, and they are too costly to construct and simply not practical or feasible.

The invention proposed by this application can be constructed at a fraction of the cost compared to other alternatives and it could be completed nationwide in only a few years once it becomes shovel ready. The best aspect of this invention is the fact that it does not require any outside power source to be functional and charge EVs.

### SUMMARY OF THE INVENTION

The present invention proposes installation of magnetic bars flush with the surface of pavements. The dimensions, spacing and number of these bars to be determined by EV makers to meet their requirements for optimum performance.

Obviously the present invention requires full cooperation and adoption by Federal and State Transportation Departments. Fortunately, the current Administration and even some of the states like California are fully aware of this looming climate disaster and are fully supporting, promoting and even subsidizing green energy innovations.

As a retired road and bridge construction engineer, I am certain these magnetic bars can be easily, quickly and economically installed on pavements without posing any danger to motorists. These magnetic bars shall be installed using equipment and technology readily available and regularly being utilized.

These magnetic bars shall be installed using the same material approved for highway application in the same method and manners commonly used for installation of Raised Pavement Markers (RPMs), Rumble Strips and many other instruments or devices embedded in pavements for various purposes.

In short, installation and presence of these bars in pavements throughout the nation's Interstates and State Highways is entirely in line with road construction practices and devices already out there and most likely won't even be noticed by motorists.

The present invention also requires installation of a winding coil beneath electric vehicles to work in tandem with magnetic bars. The dimensions and number of these winding coils along with their specifications is to be determined by EV makers to meet their requirements for optimum performance.

### DESCRIPTION OF THE VIEWS OF THE DRAWINGS

FIG. 1 Perspective view of the invention. It shows an electric vehicle traveling over magnetic bars.

FIG. 2 Profile view of the invention. It shows the EV with its winding coil retracted up in its housing. Not in use.

FIG. 3 Plan view of the EV on the road with its winding coil over the magnetic bars.

FIG. 4 Profile view of the EV with the winding coil extended down to hover over the magnetic bars. In charging mode.

FIG. 5 Cross section AA. Through the EV and pavement. Also showing a magnetic bar and the winding coil.

FIG. 6 Various views of magnetic bars in the pavement.

FIG. 6a Plan view of bars secured in pavement by epoxy. FIG. 6b Cross section BB longitude view of the bars and epoxy in pavement.

FIG. 6c Cross section CC transverse view of the bar and epoxy in pavement.

FIG. 7 Winding coil. Their exact geometry and size are determined by EV makers to meet their requirements.

### DETAILED DESCRIPTION OF THE INVENTION AND HOW IT WORKS

1 Electric vehicle (EV).
2 Surface of the pavement with cavities cut into it.
3 Magnetic bars embedded in pavement cavities.
4 Winding coil.
5 Mechanical or electric actuator to position the winding coil.
6 Pin and hanger links for supporting the winding coil.
7 Actuator link with on/off switch to raise or lower the winding coil.
8 Winding coil's housing.
9 Primary EV battery cell.
10 Epoxy bonding compound approved for highway application.
11 Shield for protection and aerodynamic purposes.

### How it Works

Once all the parameters of the components have been established and they are put in place as described, the motorists will be able to charge their EVs while they are being driven at designated speed as if a generator is attached to them to keep their batteries charged up.

All the driver must do is just to simply drive over the lane or lanes that have the magnetic bars 3 embedded in them and lower the winding coil (4) via switch (7) located on the dash. Preferably and ideally, it would be best if sensors automatically perform this function for all practical purposes.

The bars shall be installed for hundreds of miles on the Interstates. They could be installed intermittently like every other mile or every other ten-mile stretch of the highway if possible and still functional, to make them more economical. These kinds of variables could eventually be tweaked for optimum output and efficiency by further testing and trials.

In part A, a contract with proposal, specifications and drawings is let and a contractor wins to perform the installation of magnetic bars onto the pavement on designated miles of a highway at a certain location indicated in the contract.

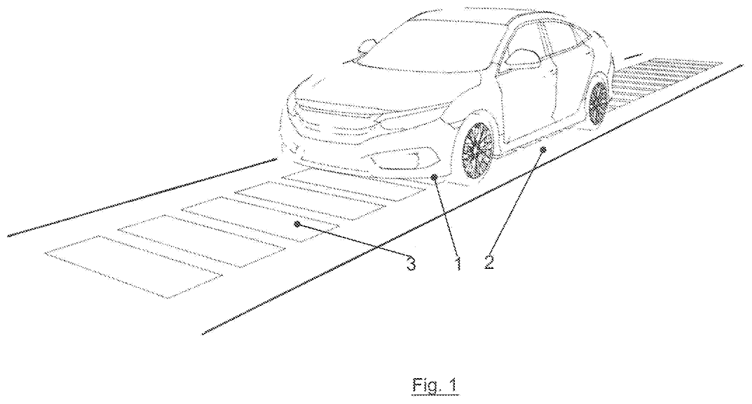

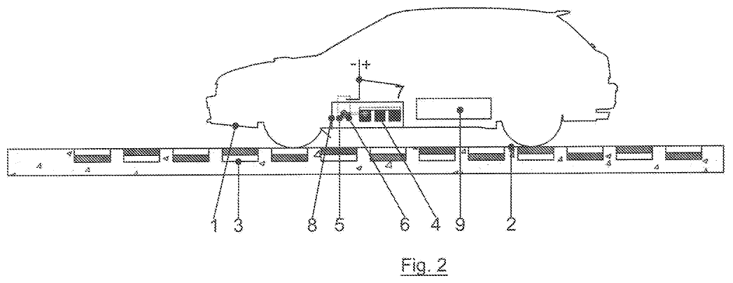

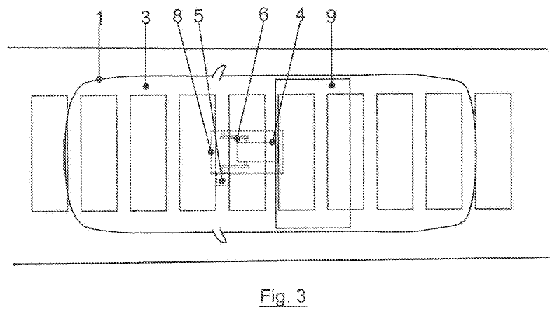

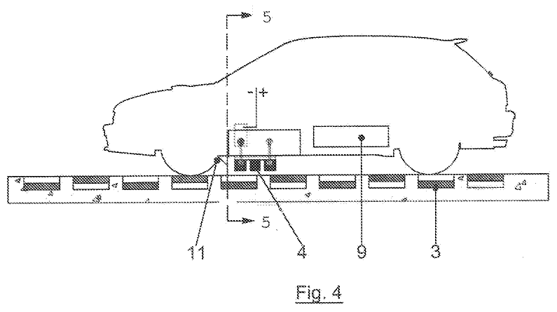

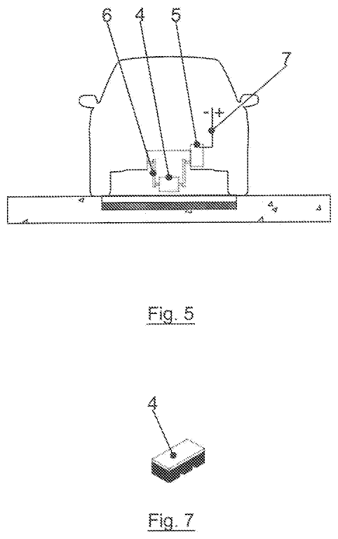

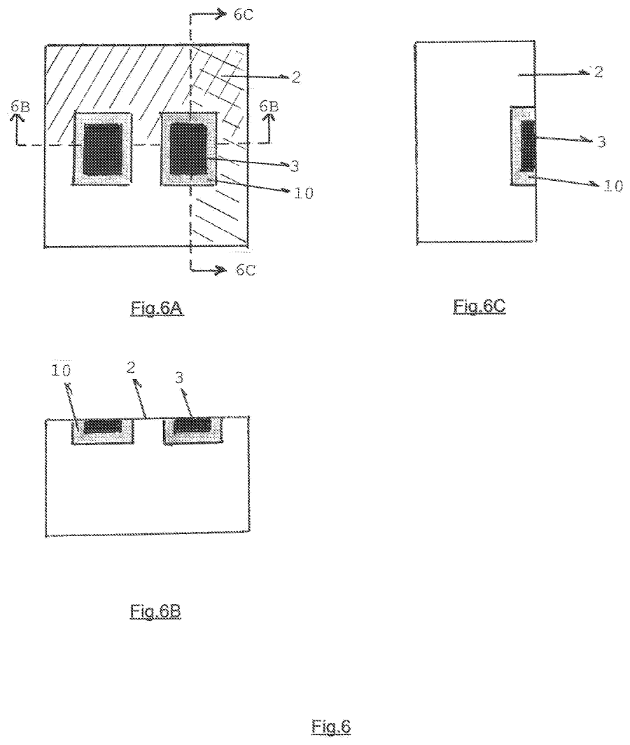

Following the lane closure, a convoy of equipment and crew first begin to cut cavities onto the surface of the pavement as designated in the plans using diamond-tipped saws. Like the layout shown in FIG. 1.

Right behind them, the next crew coats the cavities with epoxy bonding compound approved for highway application and drops in the magnetic bars and tools them flush with the surface of the pavement. Once the epoxy is cured the lane is opened back up to traffic.

Part B, requires installation of a winding coil underneath EVs. These winding coils are manufactured and installed in EVs in collaboration between EV makers.

Once these two parts are complete, the EV drivers can simply head out of the city using their overnight charge. Once they reach these lanes of the highways equipped with magnetic bars, they will lower their winding coil and drive for unlimited miles while their batteries are getting charged without stopping or needing any charging stations or causing any pollution.

What is presented here is all Twentieth Century technology. Everything needed is readily available. It could be implemented and put to work safely, economically and quickly without any harmful byproducts. As was stated earlier it will not tax the power grids and there is no waiting around to get your batteries charged in stations.

EVs can drive coast to coast nonstop forever without an ounce of carbon emission, without taking a single amp off the grids or wasting a second of their time in charging stations.

Claims and Abstract on following pages. There is also a detached abstract sheet.

1. The invention claimed is an electric vehicle (EV) charging apparatus, comprising:
magnetic bars embedded in the surface of the pavements, and
a winding coil mounted beneath EVs by pin and hanger links.

2. A charging apparatus as in claim 1, further comprising:
an electronic actuator to lower said winding coil over said magnetic bars.

3. A charging apparatus as in claim 1, wherein said magnetic bars are secured flush with the surface of the pavement using epoxy bonding adhesive.

4. A charging apparatus as in claim 3, wherein said pavement is indented with cavities previously saw cut to house the magnetic bars.

5. A charging apparatus as in claim 1, wherein the winding coil is protected with an aerodynamic shield against debris.
